(19) United States
(12) Patent Application Publication
(10) Pub. No.: US 2015/0199722 A1
(43) Pub. Date: Jul. 16, 2015

(54) DIRECTING MARKETING NOTIFICATIONS IN A CUSTOMER DEVIANT LOCATION

(71) Applicant: fisoc, Inc., Austin, TX (US)

(72) Inventors: Wesley Gottesman, Austin, TX (US); Brian Rainey, Austin, TX (US); David H. Fruhling, II, Austin, TX (US); Jay P. Valanju, Austin, TX (US); Daniel Edward Kim, Austin, TX (US)

(21) Appl. No.: 14/593,685

(22) Filed: Jan. 9, 2015

Related U.S. Application Data
(60) Provisional application No. 61/926,593, filed on Jan. 13, 2014.

(51) Int. Cl. G06Q 30/02

(52) U.S. Cl. CPC G06Q 30/0261; G06Q 30/0267

(57) ABSTRACT

Directing marketing notifications in a customer deviant location is achieved by identifying log in locations and transactions that break regular patterns. Once it is determined that a customer is located in a deviant location, an automated customized marketing campaign is sent to the customer for the new location using both the user's account information and home spending activity and the new city information.

### CROSS-REFERENCES TO RELATED APPLICATIONS

This application claims the benefit of U.S. Provisional Patent Application Ser. No. 61/926,593, filed Jan. 13, 2014, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to optimizing user interaction with a marketing or rewards product as they leave their typical location. More particularly, the invention relates to utilizing an extensive network to drive customer engagement after it is determined that the customer is in a location that deviates from a normal or baseline area range for customer spending activity.

Currently, notifications have been built for abnormal spending and log ins solely for fraud detection purposes. Nothing has been built for locational abnormalities in transaction or logins that are trigger focused, automated marketing materials for the individual user. Such directed marketing will cut down on blind marketing and enable more customized and effective marketing approaches.

### BRIEF SUMMARY OF THE INVENTION

It would be desirable for a system that could automatically generate marketing materials customized for a new user location, triggered immediately when a variant log in or transaction occurs. In a member rewards program, the system has access to transaction activity on a customer's debit card, and the system can thus determine when a transaction takes place in a location deviant from traditional spending. Using this information, it would be desirable to reach out to the consumer about opportunities in the new trade area. The system may monitor and/or track browser log in data to help determine a new user location (outside of a preset radius, e.g., 100 miles, of typical log in behavior) who may be using other spending tools (i.e., tools that the system is unable to monitor). In either circumstance, a flag in the behavior will trigger marketing materials for the user's new location.

In an exemplary embodiment, a method of directing marketing notifications in a customer deviant location includes the steps of (a) a processor determining a baseline area range for customer spending activity based on a spending history or shopping pattern of the customer; (b) the processor accessing and monitoring customer transaction activity; (c) the processor identifying when the customer is outside of the baseline area range; and (d) when the customer is outside of the baseline area range in the customer deviant location, the processor pushing marketing notifications that are local to the deviant location to the customer based on the customer spending activity in the baseline area range.

Step (b) may be practiced by monitoring debit card transactions conducted by the customer. Step (c) may be practiced based on the monitoring in step (b). Step (c) may be practiced by accessing a GPS unit on the customer's mobile phone. Step (c) may be practiced by customer log in. Step (d) may be practiced by sending an e-mail to the customer. The marketing notifications may include rewards and offers that can be validated in the deviant location. The method may further include identifying when the customer has returned to the baseline area range, and repeating steps (b)-(d). Step (d) may be practiced by analyzing a data structure according to the customer spending activity in the baseline area range, and transforming the data structure to determine the marketing notifications that are local to the deviant location.

In another exemplary embodiment, a method of automated e-mail marketing triggered by deviant location mappings includes the steps of (a) a processor tracking locational norms based on a customer transaction or customer log in; (b) the processor identifying deviations from the norms; and (c) when the processor identifies a deviation from the norms, the processor generating and sending a marketing e-mail to the customer with rewards or offers relevant to the deviant location. Step (c) may be practiced by analyzing a data structure of a customer spending history in the locational norm, and defining a corresponding data structure for the deviant location such that the rewards or offers relevant to the deviant location are determined based on the customer spending history in the locational norm.

In yet another exemplary embodiment, a computer system directs marketing notifications to a customer mobile phone in a customer deviant location. The computer system includes a memory storing a marketing notification computer program, and a processor that executes the marketing notification computer program to determine a baseline area range for customer spending activity based on customer shopping activity. Deviant location determining hardware cooperable with the processor is configured to identify when the customer is outside of the baseline area range. The deviant location determining hardware monitors the customer shopping activity. Communication hardware cooperable with the processor is configured to push marketing notifications that are local to the deviant location to the customer mobile phone based on the customer spending activity in the baseline area range when the customer is outside of the baseline area range.

### BRIEF DESCRIPTION OF THE DRAWINGS

These and other aspects and advantages will be described in detail with reference to the accompanying drawings, in which:

FIG. 1 is a block diagram showing an overall system linked to a network of mobile devices;

FIG. 2 is an exemplary marketing notification; and

FIG. 3 is a flowchart showing system steps for directing marketing notifications in a customer deviant location.

### DETAILED DESCRIPTION OF THE INVENTION

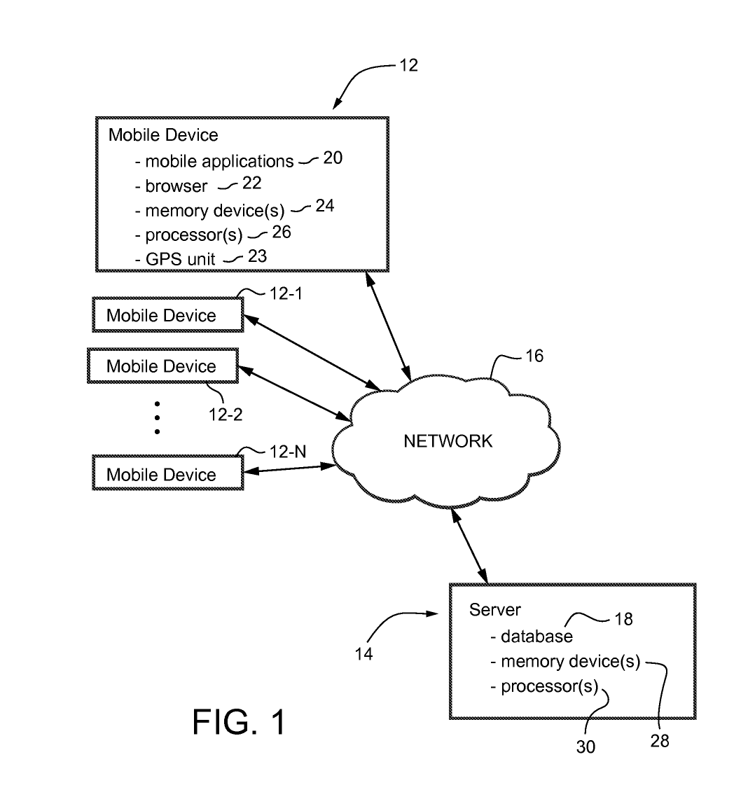

FIG. 1 shows a block diagram illustrating an overall system 10 in which a mobile device 12 transmits a request to, and receives content from, a server 14 via a network 16. Network 16 may be the Internet, a cellular network, a wired network, a wireless network, a cloud computing network, or other conventional network technology as generally recognized in the art. It is to be understood that, in practice, there will be plural and likely a very large number of mobile devices (12-1, 12-2 . . . 12-N) connected to the network 16. Also, the server 14 may be a unitary device but would preferably be implemented as a server farm or a distributed computing system in order to handle large capacities of content stored in a database 18 and the many simultaneous connections with mobile devices 12.

The mobile devices 12 may include conventional components such as one or more mobile applications 20, a browser 22, a GPS unit 23, one or more memory devices 24, and one or more processors (CPUs) 26. Conventional components such as displays, speakers, microphones, connectors, and input devices may also be included in the mobile device 12 as is well known. Examples of mobile devices 12 include such known devices as smart phones, tablets, etc., but it is to be understood that the device 12 need not be a mobile device and that the inventive concepts apply to other computing devices such as a desktop PC.

The server 14 may similarly include conventional components such as one or more memory devices 28 and one or more processors (CPUs) 30.

The execution of a typical software program illustrates that software implemented processes perform rapid activation and deactivation of transistors. Software defined instructions operate on the information stored within transistor elements. A software program may perform hundreds of millions of such operations per second. In essence, software instructions temporarily reconfigure electronic pathways and transform computing hardware to perform real, useful, and physical activity.

When an algorithm is implemented in software, it necessarily controls the hardware components to carry out computerized actions. The software thus transforms a computer into different machines and provides very different experiences.

Structure for execution of mobile software technology is described in many U.S. patents and published U.S. patent applications, for example, U.S. Pat. No. 8,694,520 and U.S. Publication No. 2014/0324692, the contents of which are hereby incorporated by reference.

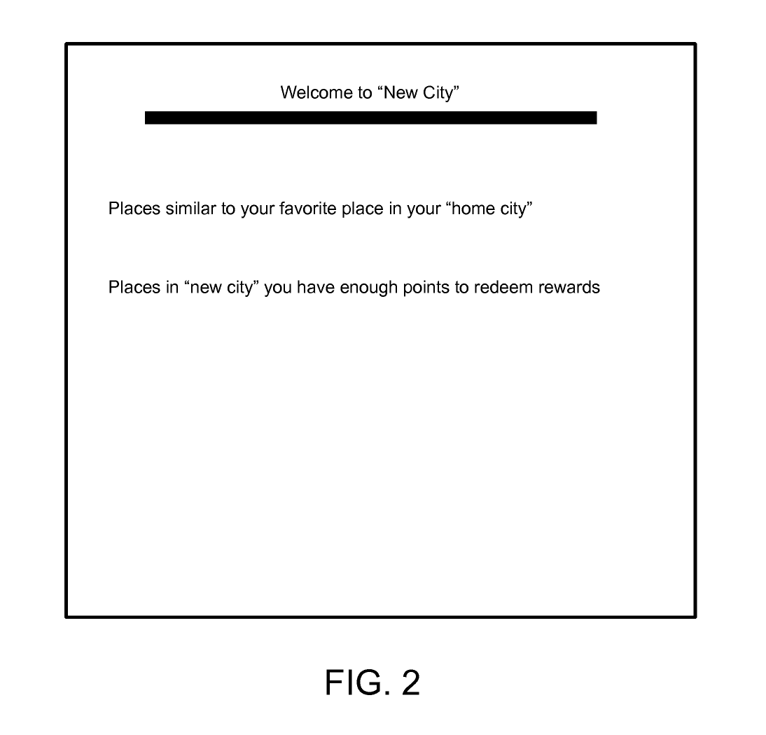

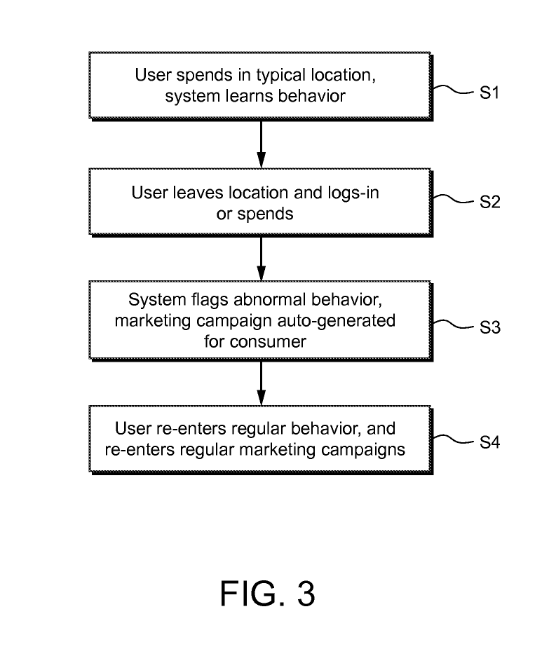

With reference to FIGS. 2 and 3, the processor determines a baseline area range for customer spending activity based on a spending history or shopping pattern of the customer (step S1). The system thus learns a user's normal transaction and log in locations. As a consequence, the system is able to recognize when marketing materials hold value for the customer and when certain materials would be useless to a customer. For example, if it is determined that the user is in a location outside of their baseline area range, and the system knows that store A is not located near the user's current location, the system will not send a marketing notification relating to store A. Atypical marketing materials may then be customized for each individual user in a deviant location, thereby presenting extensive value to that user/customer.

The processor accesses and monitors customer transaction activity. In an existing rewards program, the system has access to customer debit card transactions and can also identify a customer location based on browser log in data. Thus, when the user/customer leaves the baseline area range and logs into the system or conducts a transaction (step S2), the system identifies that the customer is outside of the baseline area range and automatically generates a marketing campaign for the new location (step S3).

In a preferred embodiment, a deviation from the baseline area range will immediately and automatically trigger an email to the customer welcoming them to the new trade area with an array of tools for their visit pulled from their account information (see FIG. 2). The array of tools may include recommendations in the new location based on transactions in their “home” transaction city or baseline area range, as well as rewards and offers that can be validated in the new location. That is, when the customer is outside of the baseline area range in the customer deviant location, the processor pushes marketing notifications that are local to the deviant location to the customer based on the customer spending activity in the baseline area range. Specifically, the system may analyze a data structure according to the customer's spending activity in the baseline area range and subsequently transform the data structure to determine the marketing notifications that are local to the deviant location. This process will repeat for every new city the customer enters, while also returning the customer to the normal cycle of marketing when they re-enter the baseline area range (step S4).

In other embodiments, the system can access the GPS unit on the customer's mobile phone in order to identify when the customer is outside of the baseline area range.

Deviant locations may be determined by activity transactions outside of the baseline area range according to a locational norm radius. For example, deviant locations may be determined by activity transactions or a log in or the like outside of a 100 mile radius of the baseline area range.

The system thus automatically generates marketing materials customized for a new or variant location, triggered immediately when a variant log in or transaction occurs.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of directing marketing notifications in a customer deviant location, the method comprising:
(a) a processor determining a baseline area range for customer spending activity based on a spending history or shopping pattern of the customer;
(b) the processor accessing and monitoring customer transaction activity;
(c) the processor identifying when the customer is outside of the baseline area range; and
(d) when the customer is outside of the baseline area range in the customer deviant location, the processor pushing marketing notifications that are local to the deviant location to the customer based on the customer spending activity in the baseline area range.

2. A method according to claim 1, wherein step (b) is practiced by monitoring debit card transactions conducted by the customer.

3. A method according to claim 1, wherein step (c) is practiced based on the monitoring in step (b).

4. A method according to claim 1, wherein step (c) is practiced by accessing a GPS unit on the customer's mobile phone.

5. A method according to claim 1, wherein step (c) is practiced by customer log in.

6. A method according to claim 1, wherein step (d) is practiced by sending an e-mail to the customer.

7. A method according to claim 1, wherein the marketing notifications comprise rewards and offers that can be validated in the deviant location.

8. A method according to claim 1, further comprising identifying when the customer has returned to the baseline area range, and repeating steps (b)-(d).

9. A method according to claim 1, wherein step (d) is practiced by analyzing a data structure according to the customer spending activity in the baseline area range, and transforming the data structure to determine the marketing notifications that are local to the deviant location.

10. A method of automated e-mail marketing triggered by deviant location mappings, the method comprising:
(a) a processor tracking locational norms based on a customer transaction or customer log in;
(b) the processor identifying deviations from the norms; and
(c) when the processor identifies a deviation from the norms, the processor generating and sending a marketing e-mail to the customer with rewards or offers relevant to the deviant location.

11. A method according to claim 10, wherein step (a) is practiced by monitoring customer debit card transactions.

12. A method according to claim 10, wherein step (b) is practiced by defining a locational norm radius and identifying when the customer has left the locational norm radius.

13. A method according to claim 10, wherein step (c) is practiced by analyzing a data structure of a customer spending history in the locational norm, and defining a corresponding data structure for the deviant location such that the rewards or offers relevant to the deviant location are determined based on the customer spending history in the locational norm.

14. A computer system for directing marketing notifications to a customer mobile phone in a customer deviant location, the computer system comprising:
a memory storing a marketing notification computer program;
a processor that executes the marketing notification computer program to determine a baseline area range for customer spending activity based on customer shopping activity;
deviant location determining hardware cooperable with the processor and configured to identify when the customer is outside of the baseline area range, the deviant location determining hardware monitoring the customer shopping activity; and
communication hardware cooperable with the processor that is configured to push marketing notifications that are local to the deviant location to the customer mobile phone based on the customer spending activity in the baseline area range when the customer is outside of the baseline area range.

15. A computer system according to claim 14, wherein the deviant location determining hardware is configured to monitor debit card transactions conducted by the customer.

16. A computer system according to claim 14, wherein the deviant location determining hardware is configured to access a GPS unit on the customer mobile phone.

17. A computer system according to claim 14, wherein the communication hardware comprises means for generating and sending an e-mail to the customer.

18. A computer system according to claim 14, wherein the marketing notifications comprise rewards and offers that can be validated in the deviant location.

19. A computer system according to claim 14, wherein the processor is configured to analyze a data structure according to the customer spending activity in the baseline area range, and transform the data structure to determine the marketing notifications that are local to the deviant location.
